(19) United States
(12) Patent Application Publication
(10) Pub. No.: US 2025/0296548 A1
(43) Pub. Date: Sep. 25, 2025

(54) PLUG-IN HYBRID DRIVE

(71) Applicant: Michael C. Argento, Mission Viejo, CA (US)

(72) Inventor: Michael C. Argento, Mission Viejo, CA (US)

(21) Appl. No.: 19/081,667

(22) Filed: Mar. 17, 2025

Related U.S. Application Data
(60) Provisional application No. 63/567,074, filed on Mar. 19, 2024.

(51) Int. Cl. B60W 20/13; B60K 6/48; B60K 13/04; B60W 10/06; B60W 10/08; B60W 30/18

(52) U.S. Cl. CPC B60W 20/13; B60K 6/48; B60K 13/04; B60W 10/06; B60W 10/08; B60W 30/18127; B60W 2510/246; B60W 2710/244; B60W 2710/246; B60Y 2200/92

(57) ABSTRACT

A plug-in hybrid electric drive system is disclosed which is designed to optimize vehicle efficiency by integrating an electric drive with an internal combustion (IC) engine. The electric drive system propels the vehicle from a standstill to a predetermined midrange speed, such as 50 mph, utilizing a battery bank and a multi-speed transmission. Beyond this speed, the IC engine engages through a separate transmission to power the vehicle at higher speeds. The system enables full regenerative braking at all speeds and eliminates the need for a hydraulic torque converter, enhancing overall drivability. An electronic controller manages both drive systems, allowing seamless transitions and optional battery charging via the IC engine when needed. Additionally, the system can use waste heat from the IC engine's exhaust to maintain optimal battery temperature, ensuring reliable electric operation in cold conditions. This hybrid configuration enhances vehicle performance by efficiently managing power sources for different driving conditions.

### CROSS-REFERENCE TO RELATED APPLICATIONS

This application claims priority to Prov. Pat. App. Ser. No. 63/567,074, filed on 2024 Mar. 19, the entire contents of which are expressly incorporated herein by reference.

### BACKGROUND

The present disclosure relates in general to hybrid electric drive systems for higher speed vehicles capable of being driven on highways at the highest speed limits, and in particular to a highly efficient plug-in hybrid electric drive system for that application. High-powered internal combustion (IC) engines are very inefficient and highly polluting when driving vehicles in heavy, stop and go urban traffic. But IC engines can be more efficient and less polluting when driven at a consistent higher speed, and the correct RPM and operating temperature, like normal freeway and highway driving. Accordingly, a need remains for a hybrid electric drive system that would drive a vehicle very efficiently with an electric motor in normal urban traffic or on a crowded, stop and go or slow speed condition on a highway, and would drive the vehicle with an IC engine at higher speeds.

### BRIEF DESCRIPTION OF THE DRAWINGS

Embodiments of the present disclosure will now be described hereinafter, by way of example only, with reference to the accompanying drawings in which:

FIG. 1 shows a plug-in hybrid system in which the electric drive system and the IC engine drive system both drive the same drive wheel assembly, according to some aspects of the present disclosure.

FIG. 2 shows a plug-in hybrid system, in which the electric drive system and the IC engine drive system drive different drive wheel assemblies, according to some aspects of the present disclosure.

FIG. 3 shows a plug-in hybrid system, in which the transmission for the IC engine is of the planetary type where the input and output shafts rotate on the same axis, according to some aspects of the present disclosure.

FIG. 4 shows a plug-in hybrid system, in which the electric drive system drives a different drive wheel assembly than the IC engine drive system, and in which the transmission for the IC engine is of the planetary type where the input and output shafts rotate on the same axis, according to some aspects of the present disclosure.

### DETAILED DESCRIPTION

The present disclosure is directed to a drive system that addresses the above, and other needs. In some aspects, the system disclosed herein can provide a plug-in hybrid electric drive system that can drive a vehicle very efficiently, at low speeds in heavy stop and go traffic using an electric motor and at least a two-speed automatic transmission. In some aspects, the electric drive system can quickly power the vehicle up to a predetermined midrange speed, possibly fifty miles per hour, without the IC engine operating. In some aspects, the system can also provide full regenerative braking at all speeds up to the maximum speed of the vehicle. In some aspects, the present drive system can not only increase efficiency, but due to the elimination of the necessity of the torque converter can also reduce the weight of the vehicle and can reduce the cost of the transmission to not have the requirement to include it. In some aspects, the system of the present disclosure can allow utilizing the heated exhaust from the internal combustion (IC) engine to provide instant heat for maintaining or achieving a sufficient battery temperature, which can allow the vehicle to operate in the electric mode and continue to provide electrical current to propel the vehicle as the IC engine obtains the recommended temperature for maximum efficiency.

In some aspects, if the operator of the vehicle wants to exceed that midrange speed the IC engine can be started, if it is not already operating. Or if the IC engine is cold, the IC engine can be started by the operator a little before it is needed, and the IC engine can be warming up and generating power into the battery bank. And then the IC engine can be engaged by the operator and can drive the vehicle up to the desired speed through another automatic transmission with at least two speeds. Shortly after the IC engine is engaged by the operator the electric drive will automatically disengage. If the vehicle is traveling up a hill and the electric drive cannot drive the vehicle up to the predetermined midrange speed, the operator can start the IC engine and engage it to help the electric drive bring the vehicle up to speed. In some aspects, the IC engine can automatically disengage when it is no longer needed.

Because the IC engine is never required to power the vehicle from a standing start or at very low speed, a hydraulic torque converter is not needed. The torque converter is one of the most inefficient, energy wasting devices in the present automatic transmission.

Another advantage of the present system is that if the charge in the large battery bank gets too low the operator of the vehicle can decide to start the IC engine. Then the engine and alternator can charge the battery bank with enough current to allow the electric drive unit to operate until a charging station can be found. At the right constant speed and load, while driving an alternator, an IC engine can run very efficiently.

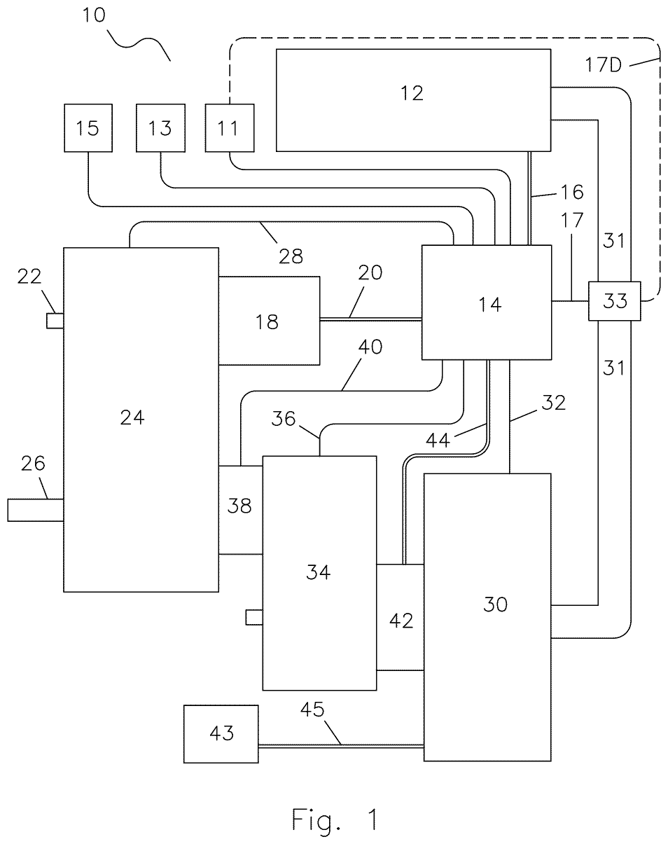

FIG. 1 shows a non-limiting, illustrative example of a hybrid drive system 10, according to some aspects of the present disclosure. As shown, the batteries 12 can supply the electronic controller 14 with power through the electric power cables 16 to operate the electric motor 18 through the electric power cables 20. The motor 18 can drive the input shaft 22 of the multi-speed electric drive transmission 24. The output shaft 26 of the transmission 24 can be directly connected to the drive wheels of the vehicle (not shown) occupied by the drive system 10.

The controller 14 can determine the correct drive ratio in transmission 24 for the speed of the vehicle and the position of the accelerator 13, and can engage that correct drive ratio when needed, through the electric cables 28. The electric drive system can quickly power the vehicle up to a predetermined speed without the IC engine running. If the operator of the vehicle needs to exceed that predetermined speed the IC engine 30 can be started. When the engine 30 is ready and the vehicle speed is high enough, the controller 14 can shift the multi-speed engine drive transmission 34 into its best drive ratio through electric cables 36 and can completely disengage the electric drive transmission 24 through electric cables 28. The controller 14 can then, through electric cables 40, engage the IC engine drive clutch 38 which can rotationally connect the output shaft (not shown) of transmission 34 to the output shaft 26 of transmission 24. The controller 14 can then bring the vehicle up to the desired speed by selecting the best drive ratio for the speed of the vehicle and the position of the accelerator 13 and can engage that ratio in transmission 34 through electric cables 36 when needed.

In some aspects, the electric drive transmission 24 of the present hybrid drive system 10 can be a highly efficient belt clutch transmission such as the belt clutch transmission shown in FIG. 6 of U.S. Pat. No. 8,608,602 B2. Belt clutches, when completely disengaged, offer no resistance to the rotation of the output shaft of the transmission 24, which the IC engine must turn to attain higher vehicle speeds. A belt clutch transmission can also allow the controller 14 to rotate the electric motor 18 in the opposite direction to run the vehicle in reverse. In some aspects, the IC engine 30 of the present system can be the highly efficient and very clean IC engine disclosed in U.S. Pat. No. 10,287,971 B2. In some aspects, the IC engine drive transmission 34 of the present system can be an efficient synchromesh transmission with electric solenoid engagement and disengagement of the gears.

In some aspects, if the charge in the large battery bank 12 gets too low the operator of the vehicle can direct the controller 14 to charge the batteries 12. The controller 14 can then shift the transmission 34 to neutral through electric cables 36 and can start the IC engine 30 through electric cables 32 and can charge the battery bank with the alternator 42 through electric power cables 44 and 16. This can produce enough current to allow the electric motor 18 to run up to full power under about 50 mph until a charging station is found.

In some aspects, in addition to the functions of the IC engine 30, the heat from the IC engine exhaust can be conveyed through a manifold 31, to the batteries 12, maintaining a practical battery operational temperature. In some aspects, the flow of the exhaust can be controlled by the operator through switch 11 to control the heat valve 33 through the heat control cable 17 through the controller 14 or directly through a dedicated control cable 17D. If at any time the operator wants to reduce the speed of the vehicle or maintain the speed on a downward slope, the controller 14 can be configured to automatically disengage clutch 38 through electric cables 40, if engaged. Then the hybrid drive system 10 can engage the correct drive ratio in transmission 24 to charge the battery bank with the electric motor 18 controlled by the position of the accelerator 13 or the foot brake 15, thereby reducing or maintaining the speed of the vehicle and saving energy through regenerative braking.

In some aspects, the electric drive transmission 24 can be constrained to limit the maximum speed of the vehicle to a certain maximum speed (e.g., 50 mph). For example, the electric drive transmission 24 can be constrained by gear ratios, by power inputs (e.g., voltage limiting, current limiting, frequency input for an AC motor), by speed sensing, by motor limitations, by a motor controller program, and by other methods known in the art. In some aspects, IC engine 30 can be configured a number of ways to provide power only above a certain minimum speed (e.g., 30 mph). For example, the IC engine 30 can be configured with speed sensing (e.g., vehicle speed or electric motor RPM). Alternatively and additionally, the IC engine 30 can be configured such that when a condition is met, an electric clutch can couple the output of the IC engine to the drive wheels. Alternatively and additionally, the IC engine 30 can include a centrifugal clutch (e.g., one or more springs set to engage at a certain RPM).

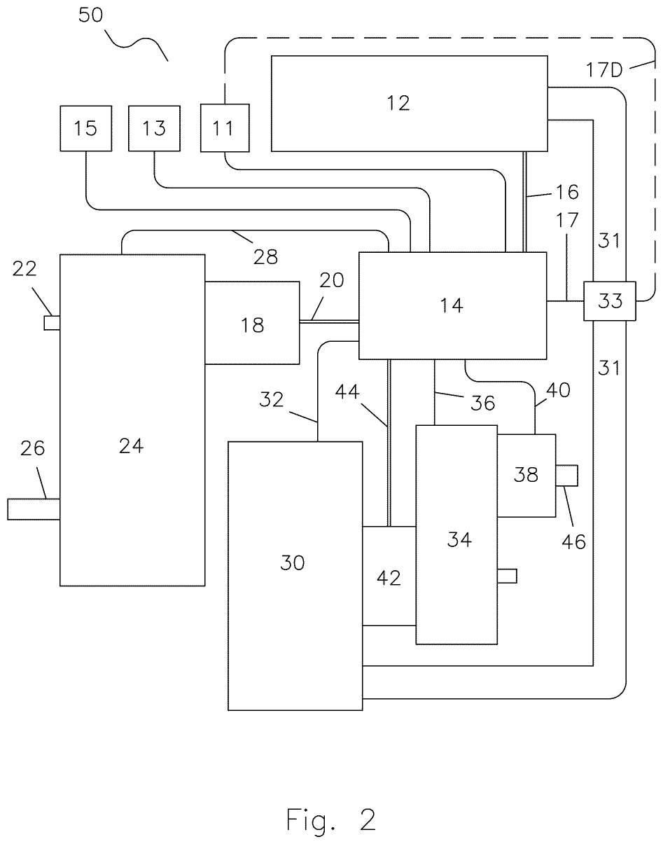

The hybrid drive system 50 shown in FIG. 2 is the hybrid drive system 10 shown in FIG. 1, except that the engine drive clutch 38 rotationally connects the output shaft (not shown) of transmission 34 to shaft 46, which can be directly connected to at least one drive wheel of the vehicle (not shown) occupied by the drive system 50. In some aspects, the output shaft 26 of the transmission 24 can be directly connected to a different wheel, or wheels of the same vehicle which means that the electric and the IC engine drive systems will drive different wheels of the vehicle occupied by the drive system 50. All the functions of the hybrid drive system 50 are the same as those described herein of system 10, unless otherwise noted.

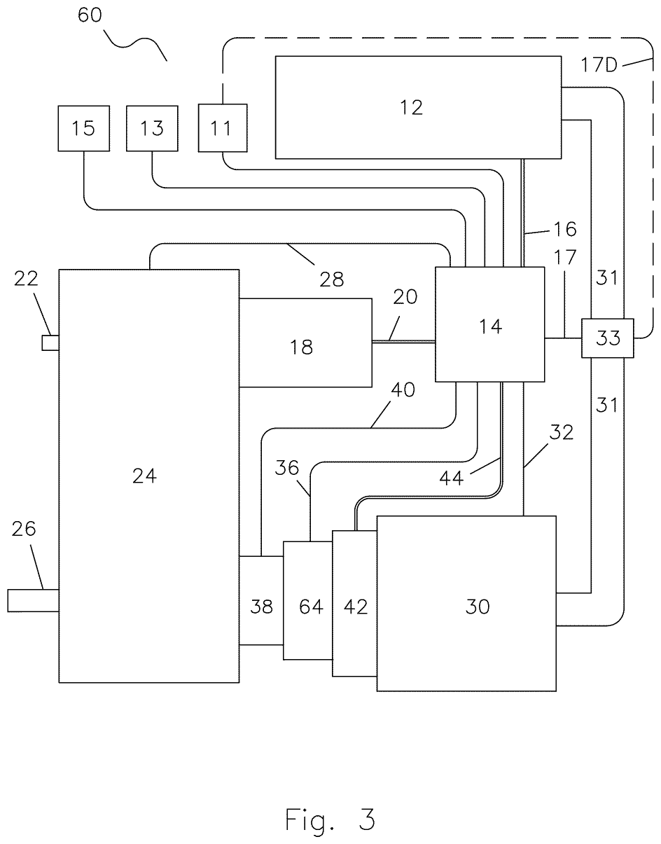

The hybrid drive system 60 shown in FIG. 3 is also the same as the hybrid drive system 10 shown in FIG. 1, except that the IC engine drive transmission 64 can be the type that has an output shaft that rotates on the same axis as the input shaft, like a two-speed planetary transmission. All the functions of the hybrid drive system 60 are the same as those described herein of system 10, unless otherwise noted.

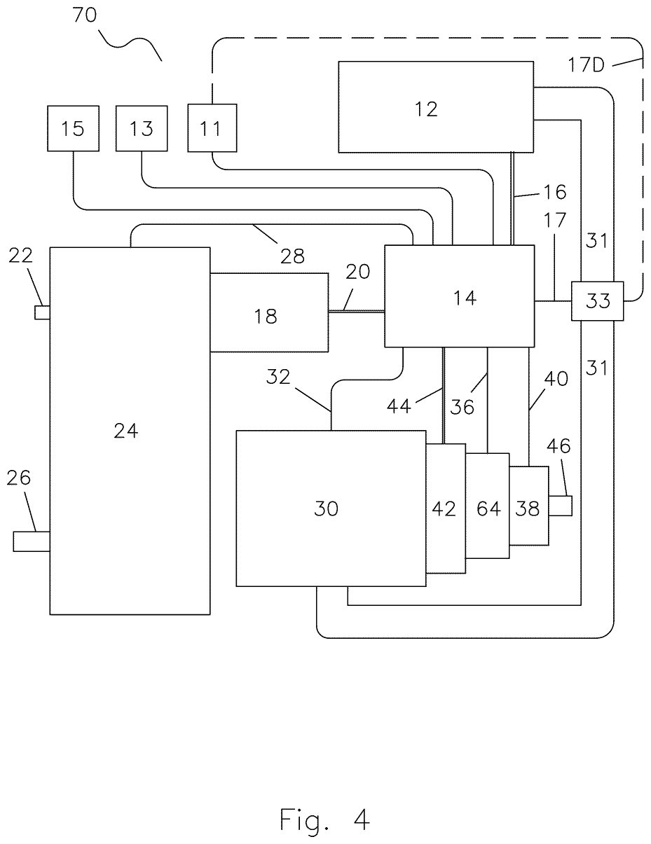

The hybrid drive system 70 shown in FIG. 4 is the same as the hybrid drive system 60 shown in FIG. 3, except that the engine drive clutch 38 rotationally connects the output shaft (not shown) of transmission 64 to shaft 46, which can be directly connected to at least one drive wheel of the vehicle (not shown) occupied by the drive system 70. The output shaft 26 of the transmission 24 can be directly connected to a different wheel, or wheels of the same vehicle, which means that the electric and the IC engine drive systems can drive different wheels of the vehicle occupied by the drive system 70. All the functions of the hybrid drive system 70 are the same as those described herein of system 10, unless otherwise noted.

### Other Variations and Terminology

While certain embodiments have been described, these embodiments have been presented by way of example only and are not intended to limit the scope of protection. Indeed, the novel methods and systems described herein may be embodied in a variety of other forms and each of those equivalent structures is within the scope of the present disclosure. It will be further understood by those skilled in the art that the present disclosure extends beyond the specifically disclosed embodiments to other alternative embodiments or uses and obvious modifications and equivalents thereof, including embodiments which do not provide all of the features and advantages set forth herein. Furthermore, various omissions, substitutions, and changes in the form of the methods and systems described herein may be made. Those skilled in the art will appreciate that in some embodiments, the actual steps taken in the processes illustrated or disclosed may differ from those shown in the figures. Depending on the embodiment, certain of the steps described above may be removed; others may be added. Accordingly, the scope of the present disclosure is not intended to be limited by the specific disclosures of preferred embodiments herein and may be defined by claims as presented herein or as presented in the future. The language of the claims is to be interpreted broadly based on the language employed in the claims and not limited to the examples described in the patent specification of during prosecution of the application, which examples are to be construed as non-exclusive.

Features, materials, characteristics, or groups described in conjunction with a particular aspect, embodiment, or example are to be understood to be applicable to any other aspect, embodiment, or example described herein unless incompatible therewith. All of the features disclosed in this specification (including any accompanying claims, abstract, and drawings), or all of the steps of any method or process so disclosed, may be combined in any combination, except combinations where at least some of such features or steps are mutually exclusive. The protection extends to any novel one, or any novel combination, of the features disclosed in this specification (including any accompanying claims, abstract, and drawings), or to any novel one, or any novel combination, of the steps of any method or process so disclosed.

Conditional language, such as “can,” “could,” “might,” or “may,” unless specifically stated otherwise, or otherwise understood within the context as used, is generally intended to convey that certain embodiments include, while other embodiments do not include, certain features, elements, or steps. Thus, such conditional language is not generally intended to imply that features, elements, or steps are in any way required for one or more embodiments. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of the stated amount. As another example, the terms “generally parallel” and “substantially parallel” may refer to a value, amount, or characteristic that departs from exactly parallel by less than 15 degrees.

What is claimed is:

1. A plug-in hybrid electric drive system for a vehicle comprising:
an electric drive system and a battery bank that can only drive the vehicle from a standing start up to a predetermined midrange speed of about 50 mph, but no higher; and
an internal combustion engine drive system that can only drive the vehicle from a predetermined lower speed of about 30 mph up to the maximum speed of the vehicle.

2. The drive system of claim 1, further comprising an electronic controller that controls the function of both drive systems with some input from the operator of the vehicle.

3. The drive system of claim 2 wherein at the demand of the operator of the vehicle the controller can start the IC engine and drive only the alternator connected to the IC engine which will charge said battery bank, without interfering with the electrical operation of said vehicle.

4. The drive system of claim 2 wherein the electric drive system can provide regenerative braking at all speeds of the vehicle.

5. The hybrid electric drive system of claim 2 comprising:
an IC engine with a starter battery that can start the engine in extremely cold weather,
wherein the exhaust from the engine is diverted over the electric drive system batteries to warm up the electric drive system batteries so that the electric drive system batteries can operate the electric drive properly.
